(19) United States
(12) Patent Application Publication
(10) Pub. No.: US 2009/0034774 A1
(43) Pub. Date: Feb. 5, 2009

(54) Earbud Assembly and Method of Decorating an Earbud Assembly

(76) Inventor: James R. Lowry, Jr., Alexandria, VA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/833,603

(22) Filed: Aug. 3, 2007

(51) Int. Cl. H04R 25/00

(52) U.S. Cl. 381/380

(57) ABSTRACT

An earbud assembly and associated method of decorating an earbud assembly are provided. The assembly generally includes a housing configured to be inserted at least partially into an ear and an electro-acoustic transducer disposed in the housing to receive electrical signals and convert the electrical signals into sounds. The housing defines a male connector that extends from a side of the housing and is configured to receive a female connector thereon so that the male connector is disposed in a cavity of the female connector and engages the female connector, thereby securing to the housing a decorative accessory that is fixedly attached to the female connector.

### BACKGROUND OF THE INVENTION

1) Field of the Invention

The present invention relates to an earbud assembly that can be provided with a decorative accessory and an associated method of decorating an earbud assembly with such an accessory.

2) Description of Related Art

Earbuds are used in products such as headphones for portable music players to convert the electrical signals from the music player to acoustic energy that is directed into a user's ear or ears. A conventional earbud includes a housing in which an electro-acoustic transducer is disposed. In use, a person wears the earbud such that the housing is disposed at least partially in the ear so that the acoustic energy from the earbud is directed toward the inner ear.

The housing of the earbud is typically formed in a size that is just large enough to house the transducer and fit comfortably in the ear, while minimizing the overall profile and noticeability of the earbud when worn. The earbud housing is often formed of plastic, which can be any of various colors such as black, gray, or white. Information relating to the manufacturer, brand, or characteristics of the earbud can be provided on the housing, but the housing is typically otherwise devoid of any substantial ornamentation. More particularly, the earbud housing can have a generally rounded shape and few or no markings or other indications thereon.

In some cases, earbuds can be decorated, e.g., by clipping a decoration thereon; however, such decorations are not integrated into the design of the earbud. In other words, the decoration must be designed to clip or otherwise attach to a portion of the earbud that is provided for other functions or reasons. Accordingly, the flexibility in connecting such decorations is limited by the design of the earbud, and providing any such decoration to the earbud can be complicated by the configuration of the earbud.

Thus, there exists a need for an improved earbud that is configured to provide a convenient attachment mechanism for a decorative accessory so that the accessory can be easily connected to the earbud to improve the aesthetic appeal of the accessory and/or provide a customized appearance to the earbud.

### BRIEF SUMMARY OF THE INVENTION

Embodiments of the present invention meet these needs and others by the use of an earbud assembly having a housing to which decorative accessories can be releasably connected by the use of male and female connectors.

According to one embodiment, the earbud assembly includes at least one housing that defines first and second opposite sides and is configured to be inserted at least partially into an ear so that the first side is directed into the ear and the second side is directed out of the ear. An electro-acoustic transducer, which is disposed in the housing is configured to receive electrical signals and convert the electrical signals into sounds that are directed in a first direction through the first side of the housing and into the ear. The housing also defines a male connector that extends from the second side of the housing along a longitudinal axis in a second direction that is generally parallel and opposite the first direction. For example, the male connector can define a cylindrical post that extends outward from the housing. In some cases, the male connector defines a base at the second side of the housing and an end distal to the base and is configured to receive a female connector thereon so that the male connector is disposed in a cavity of the female connector and engages the female connector. For example, an end of the male connector that is distal to the base can define a radial projection that is configured to engage a corresponding slot defined in the cavity of the female connector. Thus, the male connector secures the female connector along the longitudinal axis of the male connector to thereby secure to the housing a decorative accessory that is fixedly attached to the female connector. In some cases, the male connector also defines a plurality of radially extending teeth at the base. The teeth are configured to engage corresponding teeth defined in the cavity of the female connector to thereby prevent rotation of the female connector relative to the male connector about the longitudinal axis of the male connector. The decorative accessory can define such items as a gem, a lightning bolt, an arrow, a flower, a star, and a skull. The decorative accessory can also include an electronic device that is configured to be electrically connected to the transducer when the male and female connectors are engaged.

According to one embodiment, the earbud assembly includes two of the housings. Each housing has one of the transducers disposed therein and defines one of the male connectors, and the transducers are connected to a wire for providing the electrical signals to the transducers. The assembly can include one or more of the female connectors, and each female connector can be configured to be releasably connected to the housing via one of the male connectors. The decorative accessory can be fixedly attached to the female connector and thereby configured to be releasably connected to the housing by the engagement of the male and female connectors. In cases where the assembly includes multiple female connectors, the female connectors can have decorative accessories with similar configurations or decorative accessories with different and/or complementary configurations.

According to another embodiment, a method of decorating an earbud assembly includes providing an earbud assembly and inserting a male connector defined by the housing and extending from the second side of the housing into a cavity of a female connector to thereby engage the female connector so that a decorative accessory fixedly attached to the female connector is releasably connected to the second side of the housing. The male connector can be inserted relative to the female connector in a direction along a longitudinal axis of the male connector that extends a from base of the male connector to a distal end thereof. The female connector can be disconnected from the male connector to thereby remove the decorative accessory from the earbud accessory, and the male connector can subsequently be inserting into another female connector. In some cases, an electronic device in the decorative accessory can be electrically connected to the transducer and powered by electrical signals provided to the transducer.

### BRIEF DESCRIPTION OF THE SEVERAL VIEWS OF THE DRAWING(S)

Having thus described the invention in general terms, reference will now be made to the accompanying drawings, which are not necessarily drawn to scale. In the drawings:

FIG. 1 is a perspective view illustrating an earbud assembly according to one embodiment of the present invention, shown with a decorative accessory disconnected from the earbud housing;

FIG. 2 is a section view illustrating the earbud assembly of FIG. 1, as seen along line 2-2 of FIG. 1 and shown with the decorative accessory releasably connected to the earbud housing;

FIG. 3 is a partial section view illustrating the earbud assembly of FIG. 1, as seen along line 3-3 of FIG. 2;

FIGS. 4A and 4B are top views illustrating an earbud assembly according to one embodiment of the present invention with the earbud housings partially disposed in the ears of a person, shown with different decorative accessories releasably connected to the earbud housings;

FIGS. 5A and 5B are elevation views illustrating the earbud assembly of FIGS. 4A and 4B, shown with different decorative accessories releasably connected to the earbud housings;

FIG. 6 is an elevation view illustrating an earbud assembly according to another embodiment of the present invention, shown with the decorative accessory disconnected from the earbud housing;

FIG. 7 is a section view illustrating the earbud assembly of FIG. 6, as seen along line 7-7 of FIG. 6;

FIG. 8 is an elevation view illustrating the earbud assembly of FIG. 6, with the decorative accessory shown in dashed lines, connected to the earbud housing, and configured to be rotated relative to the housing about an axis perpendicular to the longitudinal axis of the male connector;

FIG. 9 is a section view illustrating an earbud assembly according to another embodiment of the present invention;

FIG. 10 is a section view illustrating the earbud assembly of FIG. 9, as seen along line 10-10 of FIG. 9; and

FIG. 11 is a section view illustrating the earbud assembly of FIG. 9, as seen along line 11-11 of FIG. 9.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

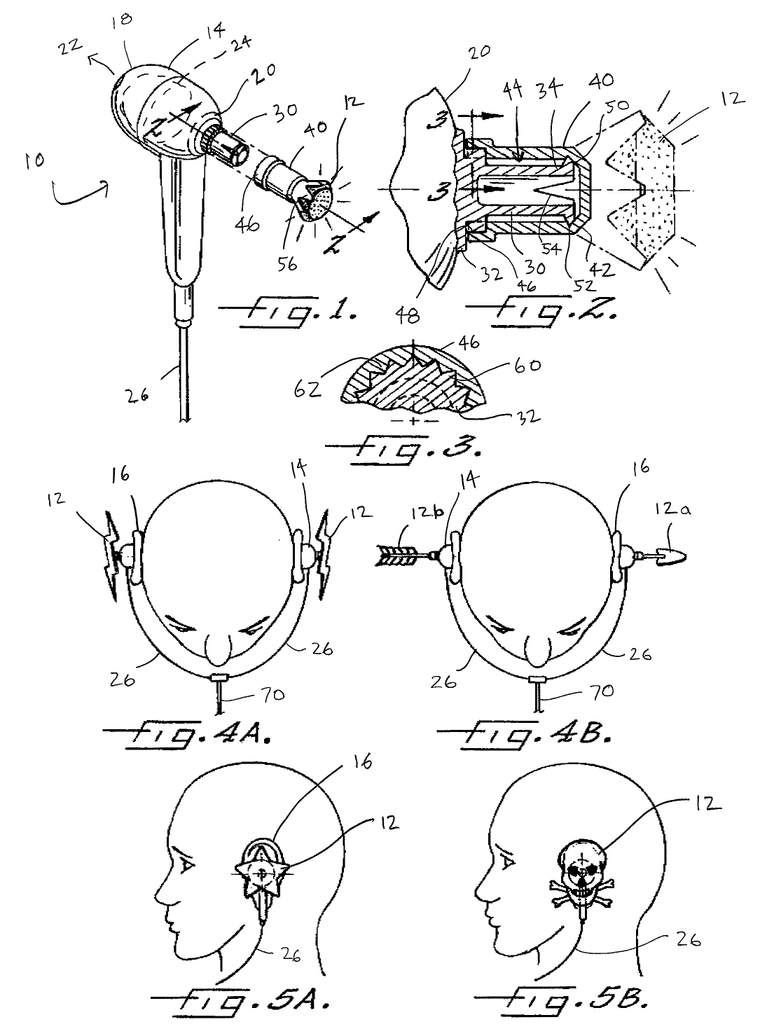

Referring to the drawings and, in particular, to FIG. 1, there is shown an earbud assembly 10 with a decorative accessory 12 according to one embodiment of the present invention. The earbud assembly 10 can be used by a person for listening to sounds generated from electrical signals, such as an electrical signal from a music player, a telephone, other radio devices, and the like. For example, the earbud assembly 10 can be used as a headphone device for listening to music or other content from a portable media player such the various iPod® devices, a registered trademark of Apple Computer, Inc. of Cupertino, Calif.

As illustrated in FIG. 1, the earbud assembly 10 generally includes a housing 14 that is configured to be inserted at least partially into the user's ear 16 (FIGS. 4A, 4B, and 5A) such that a first side 18 defined by the housing 14 is directed into the ear 16 and a second, opposite side 20 defined by the housing 14 is directed out of the ear 16. The housing 14 is typically adapted to be disposed in the outer portion of the user's ear 16 and configured so that sound emitted from the first side 18 of the housing 14 is directed generally in a first direction 22 through the first side 18 of the housing 14 and toward the inner ear 16. The second side 20 of the housing 14, which is directed out of the ear 16 can be disposed within the ear 16 or partially outside the ear 16.

The housing 14 defines an interior space in which an electro-acoustic transducer 24 is disposed. The transducer 24 is generally configured to receive electrical signals and convert the electrical signals into the sounds that are directed into the user's ear 16. The transducer 24 can be a conventional device, such as one of various types of transducers that are used in conventional headphones. In some cases, the transducer 24 can be connected to an electrical wire 26 that extends from the housing 14 to a jack or other connector that can be used to connect the wire 26 (and, hence, the transducer 24) to the portable media player or other electrical device that supplies the electrical signals. In other cases, the transducer 24 can receive the electrical signals in other manners, such as by way of a wireless receiver, which can be disposed in the housing 14 with the transducer 24 or outside of the housing 14. Such a wireless receiver can be configured to receive signals from a radio transmitter, e.g., a licensed, regional radio station or a personal area network device such as a Bluetooth® device, a registered trademark of Bluetooth SIG, Inc. of Bellevue, Wash.

The housing 14 also defines a connector 30, which extends from the second side 20 of the housing 14. In the illustrated embodiment, the connector 30 is a male connector and, in particular, a cylindrical post, that defines a base 32 at the second side 20 of the housing 14 and an end 34 distal to the base 32. The male connector 30 extends along a longitudinal axis in a second direction that is generally opposite the first direction 22 and is configured to receive a female connector 40 thereon such that the female connector 40 is directed outward from the user's ear 16. As described below, a decorative accessory 12 can be fixedly attached to a first end 42 of the female connector 40 such that the female connector 40 can be used to connect the decorative accessory 12 to the earbud housing 14, e.g., to thereby improve the aesthetic appeal of the earbud assembly 10, provide a customized appearance to the earbud assembly 10, or otherwise modify the appearance of the earbud assembly 10.

The male connector 30 is typically an integral part of the second side 20 of the housing 14, i.e., formed with at least the second side 20 of the housing 14 as a single, unified member, as illustrated in FIGS. 1 and 2. For example, the male connector 30 can be formed together with at least a portion of the housing 14 in an injection molding operation or other forming operation. In such cases, the male connector 30 cannot be removed from the housing 14 without breaking or otherwise destroying the assembly 10. It is appreciated that the housing 14 can be formed of multiple portions, e.g., two complementary parts that generally correspond to the first and second sides 18, 20 of the housing 14 and which can be snapped, glued, or otherwise affixed together. In other embodiments, the male connector 30 can be formed separately from the housing 14 and connected thereto, e.g., by snapping, gluing, screwing, or otherwise affixing the male connector 30 to the second side 20 of the housing 14. It is also appreciated that the various portions of the assembly 10 can have dimensions that vary from those of the illustrated embodiments. In particular, the male and/or female connectors 30, 40 can be considerably shorter so that the decorative accessory 12 is supported close to the housing 14 and the ear 16. In some cases, the length of the male and/or female connectors 30, 40 can be shorter than the width or diameter of the respective connectors 30, 40.

The female connector 40 defines a cavity 44 for receiving the male connector 30 for connecting the two connectors 30, 40. In particular, as shown in FIG. 2, the female connector 40 is a generally cylindrical member that defines a generally cylindrical cavity 44 and a second end 46, opposite the decorative accessory 12, that defines an opening 48. The male connector 30 can be disposed in the cavity 44 of the female connector 40 to connect the two connectors 30, 40. As shown in FIG. 2, the male connector 30 can be inserted along a longitudinal direction of the male connector 30 through the opening 48 and into the cavity 44 so that the second end 46 of the female connector 40 is disposed proximate the base 32 of the male connector 30.

The male and female connectors 30, 40 are adapted to be releasably connected or releasably secured to one another so that the decorative accessory 12 can be connected to the earbud housing 14, removed from the housing 14, and optionally replaced with another decorative accessory 12. In this regard, the male connector 30 defines a radial projection 50 at the end 34 of the male connector 30 that is distal to the base 32. The female connector 40 defines a corresponding slot 52 that extends circumferentially on the interior surface that defines the cavity 44. The dimensions and positions of the radial projection 50 and the slot 52 correspond to each other so that the projection 50 is configured to engage the slot 52 when the male connector 30 is disposed in the female connector 40. In addition, the male connector 30 can define one or more notches 54 that extend in the longitudinal direction of the male connector 30 so that the projection 50 can be flexed slightly radially inward when the male connector 30 is being inserted into or removed from the female connector 40.

By the term “releasably connected” it is meant that the female connector 40 can be released or removed from the male connector 30 (and, hence, from the housing 14) easily by the user without plastic deformation or destruction of the assembly 10. By the term “fixedly attached,” it is meant that the decorative accessory 12 is secured to the female connector 40 by a connection that, once destroyed, is not easily restored without the use of tools or adhesives. For example, as illustrated in FIG. 1, the decorative accessory 12 can be mounted on the female connector 40 by a plurality of prongs 56 that extend from the female connector 40, and the removal of the decorative accessory 12 generally requires the plastic deformation or destruction of one or more of the prongs 56. In other cases, the fixed attachment of the decorative accessory 12 can be achieved by other mechanical mounts, an adhesive, or the like.

In some embodiments, the male and female connectors 30, 40 can also be configured to engage one another to prevent a relative rotational movement between the two connectors 30, 40. In this regard, FIG. 3 illustrates a plurality of teeth 60 defined around the periphery of the male connector 30 at the base 32 of the male connector 30. The teeth 60 extend radially outward and are configured to engage corresponding teeth 62 defined in the cavity 44 on the inner periphery of the female connector 40 at the second end 46. Thus, when the male and female connectors 30, 40 are connected, as shown in FIG. 2, the engagement of the corresponding teeth 60, 62 prevents the female connector 40 from rotating relative to the male connector 30 about the longitudinal axis of the male connector 30. In this way, the rotational position of the female connector 40 can be secured relative to the male connector 30 so that a particular desired orientation of the decorative accessory 12 can be achieved and maintained even when the earbud assembly 10 is being worn by a user and even if the distribution of weight or other configuration of the decorative accessory 12 might otherwise cause the female connector 40 to rotate away from the desired orientation.

As illustrated in FIGS. 4A and 4B, the earbud assembly 10 can include two of the housings 14, each configured to be worn in one of the ears 16 of the user. Each housing 14 can have a transducer 24 disposed therein, and each transducer 24 can be connected to a wire 26 by which the electrical signals are provided to the transducers 24. In one embodiment, a common wire 70 provides the signals to both transducers 24, but it is appreciated that the transducers 24 can alternatively receive signals separately, e.g., via wireless connections. The assembly 10 of FIGS. 4A and 4B allows the user to listen to the sounds provided to the assembly 10 with both ears 16. Further, each of the housings 14 can define one of the male connectors 30 so that one of the female connectors 40 can be connected to each housing 14, thereby connecting one of the decorative accessories 12 to each housing 14. As shown in FIG. 4A, the assembly 10 includes two female connectors 40 that are releasably connected to the respective housings 14 via the male connectors 30. The female connectors 40 have decorative accessories 12 with similar configurations. By the term “similar configurations,” it is meant that the shapes of the two decorative accessories 12 are substantially the same, though one might be a mirror image of the other or different in size. FIG. 4B, on the other hand, illustrates another embodiment of the assembly 10 that also includes two female connectors 40 releasably connected to the two respective housings 14. In this embodiment, the female connectors 40 have decorative accessories 12 with different and complementary configurations. By the term “different and complementary” it is meant that the shapes of the decorative accessories 12 are dissimilar (i.e., not the same and not merely mirror images of one another or different sizes) and that the shapes complement each other by forming, in combination, a representation of a single object or theme. For example, as shown in FIG. 4B, one of the decorative accessories 12a is representative of the front portion of an arrow and the other decorative accessory 12b is representative of the tail portion of an arrow such that the two decorative accessories 12a, 12b, in combination, are representative of an arrow that appears to extend through the head of the user.

A variety of decorative accessories 12 can be provided for selectively connecting to the earbud housings 14. By way of example, FIG. 1 illustrates a decorative accessory 12 that includes a gem in a setting, the gem being any of various compositions, such as a diamond or other precious stone, a jade or other semiprecious stone, or a fake gem formed of plastic or other non-precious materials; FIG. 4A illustrates decorative accessories 12 that are representative of lightning bolts; FIG. 4B illustrates decorative accessories 12 that, in combination, are representative of an arrow; FIG. 5A illustrates a decorative accessory 12 representative of a star or a star-shaped flower; and FIG. 5B illustrates a decorative accessory 12 representative of a skull and cross bones. In other embodiments, the decorative accessories 12 can be representative of other objects or themes, such as animals, trademarked names or symbols, letters or numbers, holiday decorations, foods, people and fictional characters, and the like. As illustrated, each decorative accessory 12 can be smaller (FIG. 1) or larger (FIG. 5B) than the second side 20 of the housing 14 so that the housing 14 can be visible when the decorative accessory 12 is connected (FIG. 1) or so that the decorative accessory 12 covers the housing 14 and the housing 14 cannot be seen when viewed from the user's side (FIG. 5B). In some cases, the decorative accessory 12 can be large enough to entirely cover the user's entire ear 16, as shown in FIG. 5B.

In some cases, the decorative accessory 12 can include an electronic device. For example, the decorative accessory 12 can include a light source such as a light emitting diode or an actuator such as a motor. The electronic device can be powered by a battery in the decorative accessory 12 or otherwise provided with the female connector 40. Alternatively, the electronic device can be configured to operate using power provided by the electrical signal delivered to the transducer 24. In some cases, the housing 14 and/or the male connector 30 can provide electrical contacts that are engaged with corresponding contacts on the female connector 40 to thereby connect the electronic device of the decorative accessory 12 with the wire 26.

For example, FIG. 9 illustrates an embodiment in which the male connector 30 defines two metal electrically conductive contacts 102, 104 that extend axially therethrough. In the illustrated embodiment, each of the electrical contacts 102, 104 defines a cylindrical tube that extends from a first end 106, 108 in the interior space of the housing 14 to a second end 110, 112 proximate the decorative accessory 12, as shown in FIGS. 9-11. The first ends 106, 108 of the contacts 102, 104 are electrically connected to the transducer 24 and/or the wire 26, e.g., by elements 114, which can be wires, conductive tracings, or the like. The female connector 40 includes corresponding conductive contacts 122, 124 that are configured to contact the respective contacts 102, 104 of the male connector 30 when the male and female connectors 30, 40 are engaged. In particular, as shown in FIGS. 9 and 11, the first contact 122 of the female connector 40 is a post configured to be disposed within an aperture of the first contact 102 of the male connector 30 to thereby make electrical contact with the first contact 102. The second contact 124 of the female connector 40 can be a cylindrical tube configured to partially define the slot 52, and the second contact 104 of the male connector 30 can define the radial projection 50 such that the contacts 104, 124 touch one another when the connectors 30, 40 are engaged. Each of the contacts 122, 124 of the female connector 40 can extend into a space defined by the decorative accessory 12 and can be connected to respective electrical contacts 132, 134 of an electronic device 130 in the decorative accessory 12, e.g., by wires, conductive tracings, or the like. Thus, when the male and female connectors 30, 40 are engaged, the electronic device 130 can be electrically connected to the transducer 24 and/or the conductive strands in the wire 26 and thereby configured to be powered by the electrical signal delivered via the wire 26.

In other embodiments, other connections can be provided between the electronic device 130 and the transducer 24 and/or wire 26. For example, various conventional electrical connectors can be incorporated into the male and female connectors 30, 40. In some cases, the male and female connectors 30, 40 can be defined at least partially by any of various conventional electrical connectors, which can provide both an electrical connection for connecting the electronic device 130 to the wire 26 and a mechanical connection for engaging the decorative accessory 12 to the housing 14. For example, the male connector 30 can be the jack of a 3.5 mm or 2.5 mm TS or TRS connector, and the female connector 40 can be a corresponding socket of the same type of TS or TRS connector, both of which are conventionally used for connecting headphone sets to radios and music players.

As shown in FIG. 9, the electronic device 130 can include, e.g., an actuator 140 such as a light emitting diode (or other light), a motor, or the like. In this way, the electronic device 130 can emit light when electrical signals are delivered via the wire 26. The electronic device 130 can be disposed entirely within a space defined by the housing of the decorative accessory 12, e.g., so that a light generated by the device 130 is seen through a translucent or transparent portion of the decorative accessory 12. Alternatively, the device 130 can be disposed at least partially outside the housing of the accessory 12. In this regard, FIG. 9 illustrates a shaft 142 (in dashed lines) that extends out of the housing of the accessory 12 to support a rotatable member 144 (e.g., a rotatable decoration, such as the various decorations illustrated in FIGS. 4A, 4B, 5A, 5B, and described above), and the actuator 140 can include a motor configured to rotate the shaft 142 and the member 144.

The operation of the electronic device 130 can be controlled by the electrical signals, such as by turning a light, motor, or other actuator of the electronic device 130 on only when the earbud is in operation and/or adjusting the intensity, color, or other attribute of the light, motion, or other feature of the device 130 in response to the voltage, current, or other property of the electrical signal. In this way, the electronic device 130 can provide an indication of the use of the earbud, e.g., to indicate that the user is currently using the earbud assembly 10 to listening to music or talking on a cell phone. In some cases, the electronic device 130 can further provide an indication of a characteristic of the sounds generated by the earbud assembly 10, e.g., a rhythmic pulsing of light that indicates the rhythm of music that the user is hearing with the earbud assembly 10.

It is appreciated that decorative accessories 12 can be connected to the housing 14, disconnected therefrom, and replaced with other decorative accessories 12 by the user. Further, it is appreciated that a user may collect a plurality of the female connectors 40 with a variety of decorative accessories 12 and periodically selectively replace the decorative accessory 12 or accessories 12 on the earbud assembly 10. The replacement of a decorative accessory 12 can be performed so that the decorative accessory 12 that is selected and worn by the user matches or complements the user's clothing; so that the decorative accessory 12 corresponds to the day or time, such as a holiday or current event; so that the decorative accessory 12 indicates an expression of the user's taste, opinion, or personality, such as by indicating a particular musical performer, band, or the like; or so that the decorative accessory 12 otherwise provides a customized appearance as desired by the user.

In some embodiments, the decorative accessory 12 can be adjustably mounted on the housing 14, e.g., to achieve a desired orientation and/or motion of the decorative accessory 12 relative to the housings 14. In this regard, it is noted that the housings 14 may fit best differently in different people's ears 16. That is, the size and shape of a person's ear 16 can affect the orientation at which the housing 14 fits most comfortably. As a result, the longitudinal direction of the male connector 30 may extend generally horizontally when the earbud accessory 12 is worn by a person with his or her head in an upright position, but the male connector 30 may extend at an angle relative to the horizontal direction when worn by another person. Further, in some cases, a user may desire to wear a decorative accessory 12 in one of multiple different orientations, e.g., so that the decorative accessory 12 is supported in a particular orientation relative to the user's body, the ground, or some other reference. An adjustable joint between the housing 14 and the decorative accessory 12 can allow each user to adjust each decorative accessory 12 to a desired orientation. The joint can be provided in the male connector 30, in the female connector 40, in the decorative accessory 12, or between the various elements of the earbud accessory 12. The joint can be configured to stay in a particular position as set by the user until the user manually adjusts the decorative accessory 12 to another orientation. In addition or alternative, in other embodiments, the joint can be configured to allow the decorative accessory 12 to move freely by providing a rotary joint that allows the decorative accessory 12 to spin freely, e.g., about an axis generally parallel to the longitudinal direction of the male connector 30.

In some cases, the decorative accessory 12 can be configured to be adjusted relative to the housing 14 while connected thereto by adjusting the engagement of the teeth 60, 62. In this regard, it is noted that the engagement of the corresponding teeth 60, 62 as shown in FIG. 3 can restrict a rotation of the decorative accessory 12 about the longitudinal axis of the male connector 30. However, in some cases, the engagement of the teeth 60, 62 can be overcome when a sufficient rotational force is applied to turn the decorative accessory 12 relative to the housing 14. That is, the teeth 60, 62 can be adapted to prevent a relative rotation between the male and female connectors 30, 40, and thereby maintain the decorative accessory 12 in a predetermined desired rotational position relative to the housing 14, unless a rotational force that is greater than a predetermined rotational force is applied. In this way, the teeth 60, 62 can prevent rotation of the female connector 40 during normal wear and use of the earbud assembly 10, such that the decorative accessory 12 does not inadvertently rotate, e.g., when the assembly 10 is moved, vibrated, or subjected to shocks during normal wearing and activities. If the user desires to adjust the rotational position of the decorative accessory 12, he or she can apply a sufficient relative rotational force between the male and female connectors 30, 40 so that the teeth 60, 62 of each connector 30, 40 are unseated from the opposite connector 30, 40 and are rotated relative thereto. After rotation by the user to a desired position, the teeth 60, 62 again engage one another so that the decorative accessory 12 is maintained in the desired position.

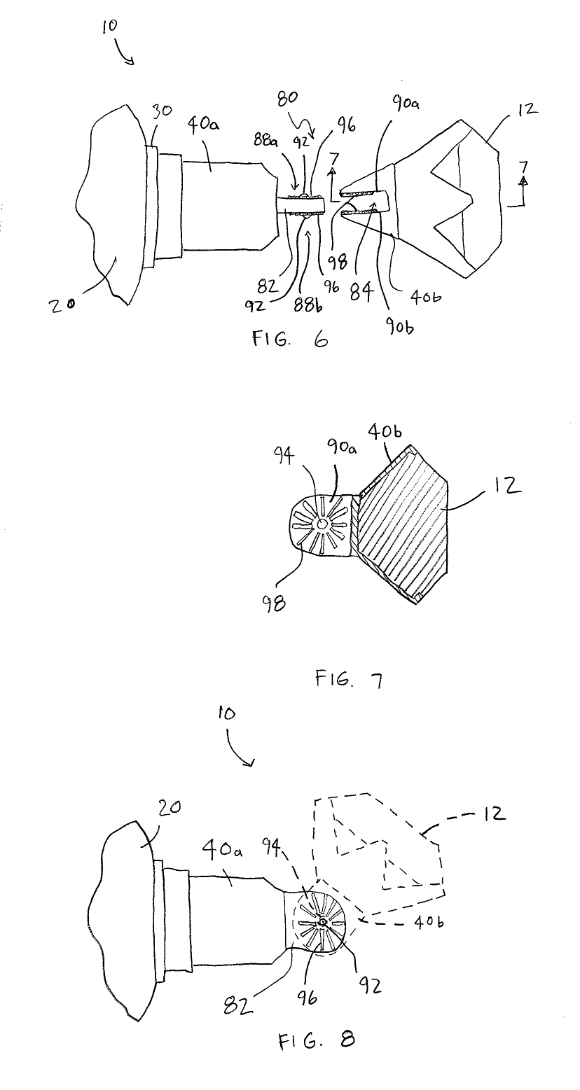

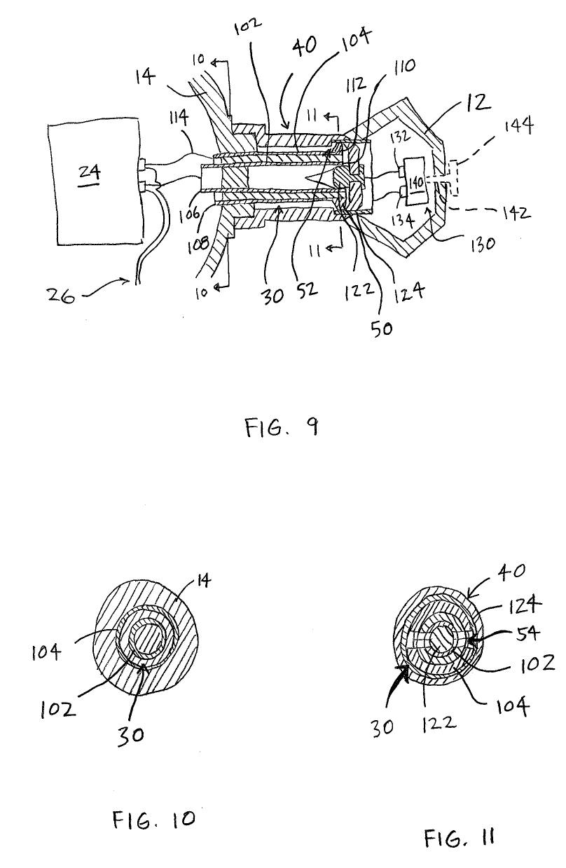

Other adjustments can also be accommodated by the earbud assembly 10 to allow other adjustments of the decorative accessory 12 relative to the housing 14. For example, as shown in FIG. 6, the female connector 40 defines an adjustable joint 80 between first and second portions 40a, 40b of the female connector 40 so that the decorative accessory 12 can be rotated relative to the housing 14 about an axis that is generally perpendicular to the longitudinal axis of the male connector 30. The first portion 40a connects to the male connector 30, and the second portion 40b defines a holder for the decorative accessory 12. The joint 80 includes a projection 82 that extends from the first portion 40a to be received in a slot 84 defined by the second portion 40b. In particular, the projection 82, which can have a substantially planar configuration with two opposite sides 88a, 88b, can be configured to be inserted into a corresponding slot 84 of the second portion 40b so that each side 88a, 88b of the projection 82 is disposed toward and against a corresponding side 90a, 90b of the slot 84. The projection 82 can define a bump 92 or other protrusion on each side 88a, 88b, and each side 90a, 90b of the slot 84 can define a corresponding dimple or depression 94 for receiving the bump 92 so that the projection 82 can be engaged with the second portion 40b and the decorative accessory 12 can be retained to the housing 14. The sides 88a, 88b, 90a, 90b of the projection 82 and slot 84 can also define corresponding teeth 96, 98 that extend radially outward from the bump 92 or dimple 94. When the projection 82 is inserted in the slot 84 and the bump 92 is engaged with the dimple 94, the teeth 96, 98 can engage one another to retain the second portion 40b in a particular orientation relative to the housing 14. Similar to the engagement of the teeth 60, 62, described above, the teeth 96, 98 can prevent rotation of the second portion 40b relative to the housing 14 unless a rotational force greater than a predetermined rotational force is applied. Thus, the joint 80 can allow the user to adjust the second portion 40b about an axis perpendicular to the longitudinal axis of the male connector 30 and thereby adjust the decorative accessory 12 to a desired orientation (e.g., as shown in FIG. 8) and then prevent further rotation of the decorative accessory 12 during normal wear and use so that the decorative accessory 12 is retained in the desired orientation.

It is appreciated that other configurations of joints can be provided by the assembly and, in some cases, the decorative accessory 12 can be configured to adjust about any of multiple axes or in any of multiple directions so that a desired position of the decorative accessory 12 relative to the housing 14 can be achieved and maintained during wearing. Further, as noted above, in some cases, the joint can allow some adjustment to occur freely (i.e., with very little force) so that the decorative accessory 12 tends to move when worn.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An earbud assembly comprising:
at least one housing defining first and second opposite sides and configured to be inserted at least partially into an ear such that the first side is directed into the ear and the second side is directed out of the ear; and
an electro-acoustic transducer disposed in the housing, the transducer configured to receive electrical signals and convert the electrical signals into sounds directed in a first direction through the first side of the housing and into the ear,
wherein the housing defines a male connector extending from the second side of the housing along a longitudinal axis in a second direction that is generally parallel and opposite the first direction, the male connector defining a base at the second side of the housing and an end distal to the base and configured to receive a female connector thereon such that the male connector is disposed in a cavity of the female connector and engages the female connector to secure the female connector along the longitudinal axis of the male connector to thereby secure to the housing a decorative accessory fixedly attached to the female connector.

2. An earbud assembly according to claim 1, further comprising the female connector, the female connector configured to be releasably connected to the housing via the male connector, and the decorative accessory being fixedly attached to the female connector and thereby configured to be releasably connected to the housing.

3. An earbud assembly according to claim 1 wherein the decorative accessory defines at least one of the group consisting of a gem, a lightning bolt, an arrow, a flower, a star, and a skull.

4. An earbud assembly according to claim 1 wherein the male connector defines a cylindrical post extending from the housing, the distal end of the male connector defining a radial projection configured to engage a slot defined in the cavity of the female connector.

5. An earbud assembly according to claim 4 wherein the male connector defines a plurality of teeth at the base, the teeth configured to engage corresponding teeth defined in the cavity of the female connector to thereby prevent rotation of the female connector relative to the male connector about the longitudinal axis of the male connector.

6. An earbud assembly according to claim 1 wherein the assembly comprises two of the housings, each housing having one of the transducers disposed therein and defining one of the male connectors, the transducers connected to a wire for providing the electrical signals to the transducers.

7. An earbud assembly according to claim 6, further comprising two female connectors, each female connector configured to be releasably connected to a respective one of the male connectors, and the female connectors having decorative accessories with similar configurations.

8. An earbud assembly according to claim 6, further comprising two female connectors, each female connector configured to be releasably connected to a respective one of the male connectors, and the female connectors having decorative accessories with different and complementary configurations.

9. An earbud assembly according to claim 1 wherein the female connector defines a joint configured to be adjusted to thereby rotate the decorative accessory relative to the housing.

10. An earbud assembly according to claim 9 wherein the joint is configured to adjust about an axis perpendicular to the longitudinal axis of the male connector.

11. An earbud assembly according to claim 1 wherein the male connector defines electrical contacts configured to be engaged with corresponding contacts of the female connector such that an electronic device in the decorative accessory is electrically connected to the transducer when the male and female connectors are engaged.

12. A method of decorating an earbud assembly, the method comprising:
providing the earbud assembly, the assembly comprising:
at least one housing defining first and second opposite sides and configured to be inserted at least partially into an ear such that the first side is directed into the ear and the second side is directed out of the ear; and
an electro-acoustic transducer disposed in the housing, the transducer configured to receive electrical signals and convert the electrical signals into sounds directed in a first direction through the first side of the housing and into the ear; and
inserting a male connector defined by the housing and extending from the second side of the housing into a cavity of a female connector to thereby engage the female connector such that a decorative accessory fixedly attached to the female connector is releasably connected to the second side of the housing.

13. A method according to claim 12 wherein inserting the male connector comprises inserting the male connector relative the female connector in a direction along a longitudinal axis of the male connector extending a from base of the male connector to a distal end thereof, the base being an integral part of the housing at the second side of the housing.

14. A method according to claim 12, further comprising disconnecting the female connector from the male connector and thereby removing the decorative accessory from the earbud accessory and subsequently repeating the step of inserting the male connector into a female connector.

15. A method according to claim 12, further comprising providing the decorative accessory, the accessory defining at least one of the group consisting of a gem, a lightning bolt, an arrow, a flower, a star, and a skull.

16. A method according to claim 12 wherein inserting the male connector comprises inserting a cylindrical post defining the male connector into the cavity of the female connector, the post extending from the housing and the distal end of the male connector defining a radial projection such that the projection engages a slot defined in the cavity of the female connector.

17. A method according to claim 12 wherein inserting the male connector comprises engaging a plurality of radially extending teeth at the base of the male connector with corresponding teeth defined in the cavity of the female connector such that the engagement of the teeth of the male and female connectors prevents rotation of the female connector relative to the male connector about a longitudinal axis of the male connector.

18. A method according to claim 12 wherein providing the earbud assembly comprising providing two of the housings, each housing having an electro-acoustic transducer disposed therein, the transducers electrically connected to a wire for receiving the electrical signals, and wherein inserting the male connector comprises inserting a male connector of each housing into a respective female connector to thereby releasably connect a decorative accessory to each of the housings.

19. A method according to claim 18 wherein inserting the male connectors of the housings into the female connectors comprises releasably connecting female connectors having decorative accessories with similar configurations to the two housings.

20. A method according to claim 18 wherein inserting the male connectors of the housings into the female connectors comprises releasably connecting female connectors having decorative accessories with different and complementary configurations to the two housings.

21. A method according to claim 12, further comprising adjusting a joint defined by the female connector and thereby rotating the decorative accessory relative to the housing.

22. A method according to claim 12, further comprising electrically connecting an electronic device in the decorative accessory to the transducer.
